(19) United States
(12) Patent Application Publication
(10) Pub. No.: US 2012/0318083 A1
(43) Pub. Date: Dec. 20, 2012

(54) ROTARY SHAFT DEVICE FOR SLIDING MODULE

(75) Inventor: AN SZU HSU, NEW TAIPEI CITY (TW)

(73) Assignee: FIRST DOME CORPORATION, NEW TAIPEI CITY (TW)

(21) Appl. No.: 13/160,554

(22) Filed: Jun. 15, 2011

(51) Int. Cl. F16H 21/44

(52) U.S. Cl. 74/101

(57) ABSTRACT

A rotary shaft device for a sliding module is provided for a movable and rotatable structure. The rotary shaft device includes a seat capable of assembling to the sliding module, a steering arm pivoted to the seat and formed of a rotatable type on the seat, and a tractor pivoted to the steering arm. The tractor is provided with a hand portion, so that the tractor can be attached to a rail and movable thereon by the hand portion.

### BACKGROUND OF THE INVENTION

1. Field of the Invention

The present invention relates to a rotary shaft device for an electronic device, and in particular relates to a rotary shaft device utilized to assemble to a sliding or movable body, to generate movement and rotation functions during the operational and assembling processes.

2. Description of the Related Art

For a conventional sliding cover system equipped in electronic devices such as mobile phones, notebook computers, personal digital assistants, digital cameras, e-books, etc., the sliding cover system can be reciprocally moved or slid by an external force, and a sliding cover portion of the sliding cover system is simply moved for the purpose of opening or closing.

As to the operation and movement of these kinds of sliding cover modules or sets, it is usually required cooperative components such as a movable rack, a linking plate, several elastic members, and wires or particular guide rails designed for linking and traction to assist with their opening or closing process. In conventional skills, in view of increasing the motion of a sliding cover module, a structure utilized to provide the sliding cover module with movable and slidable functions is disclosed.

A topic, related to the operation, motion and structure design of the above case, is that an assembly of a sliding component and a rotatable component provided with a swivel ring is applied therewith, incorporated with reserve and release of energy of elastic rings, elastic fasteners or springs to attain the movement and rotation of the sliding cover module. However, the whole structure design and assembly process of this conventional skill are more complicated and fell short of our expectations.

Typically speaking, these reference data described above are related to the applications and structure design of the sliding cover module or the related components thereof. However, these reference data are failed to physically teach or disclose that how to improve the conventional skills on decreasing the shakiness or swing of the sliding cover set and increasing the motion stability when the sliding cover module is operated.

Thus, it is essential to redesign a sliding cover and the related components, use patterns and applications thereof to be unique from that of the conventional skills.

### BRIEF SUMMARY OF THE INVENTION

Accordingly, the main purpose of the invention is to provide a rotary shaft device for a sliding module for a movable and rotatable structure. The rotary shaft device includes a seat capable of assembling to the sliding module, a steering arm pivoted to the seat and formed of a rotatable type on the seat, and a tractor pivoted to the steering arm. The tractor is provided with a hand portion, so that the tractor can be attached to a rail and movable at least between a first position and a second position thereon by the hand portion.

According to the rotary shaft device of the invention for the sliding module, the steering arm comprises a first arm defined with a first end and a second end and a second arm defined with a first end and a second end. In fact, the first end of the first arm and the first end of the second arm of the steering arm are pivoted to each other by a fastener and formed of a rotatable type, the second end of the first arm of the steering arm is pivoted to the seat, and the second end of the second arm of the steering arm is pivoted to the tractor. As a result, when the user drives the sliding module to move the seat, the first and second arms of the steering arm driven by the seat drives the tractor to move along the rail. It is presumed that, when the tractor is moved to the second position, the structure of the first and second arms of the steering arm is allowed to be swung or rotated so as to change the viewing angle of the sliding module.

According to the rotary shaft device of the invention for the sliding module, the hand portion of the tractor is provided with a limit portion utilized to attach or assemble with a wire (see FIG. 6), so that the tractor can be moved by the wire and the sliding module.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is an external schematic view of a rotary shaft device according to an embodiment of the present invention, wherein imaginary line represents the condition of an assembly of the rotary shaft device and a rail;

FIG. 2 is an exploded schematic view of the structure of FIG. 1, wherein imaginary line represents the arrangement relationship of a seat and a sliding module (or related components);

FIG. 3 is a schematic view of an assembly of a rotary shaft device, a fixed body and a rail according to an embodiment of the present invention, wherein imaginary line represents the location of the fixed body;

FIG. 4 is a sectional schematic view of the present invention, wherein imaginary line represents the motion of a steering arm;

FIG. 5 is another sectional schematic view, representing the folded steering arm received in the seat; and

FIG. 6 is a schematic view of a rotary shaft device of an embodiment of the invention assembled to a wire for accessory movement of a sliding module, wherein a tractor is in a second position.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

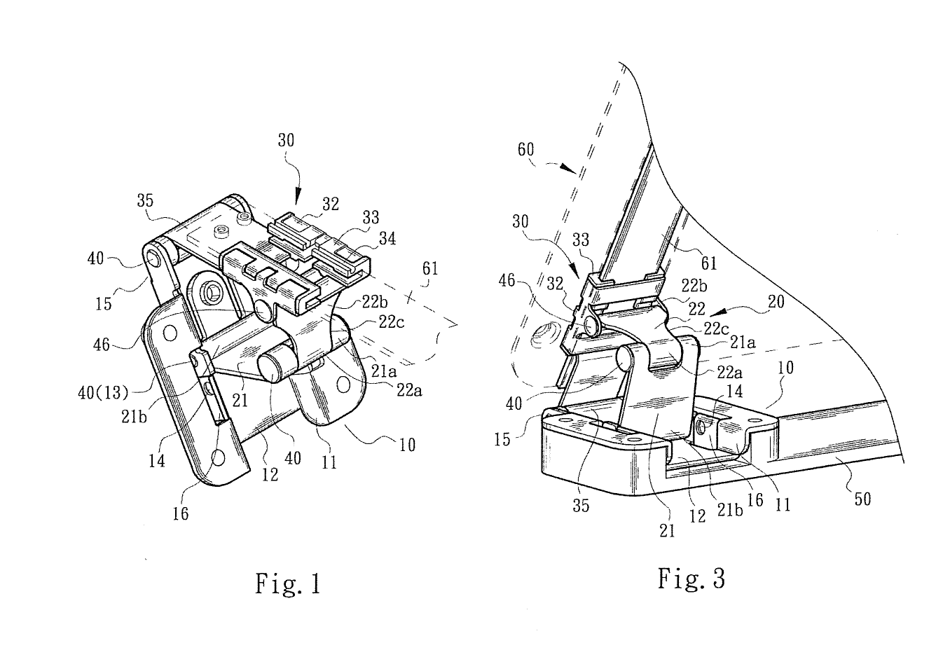

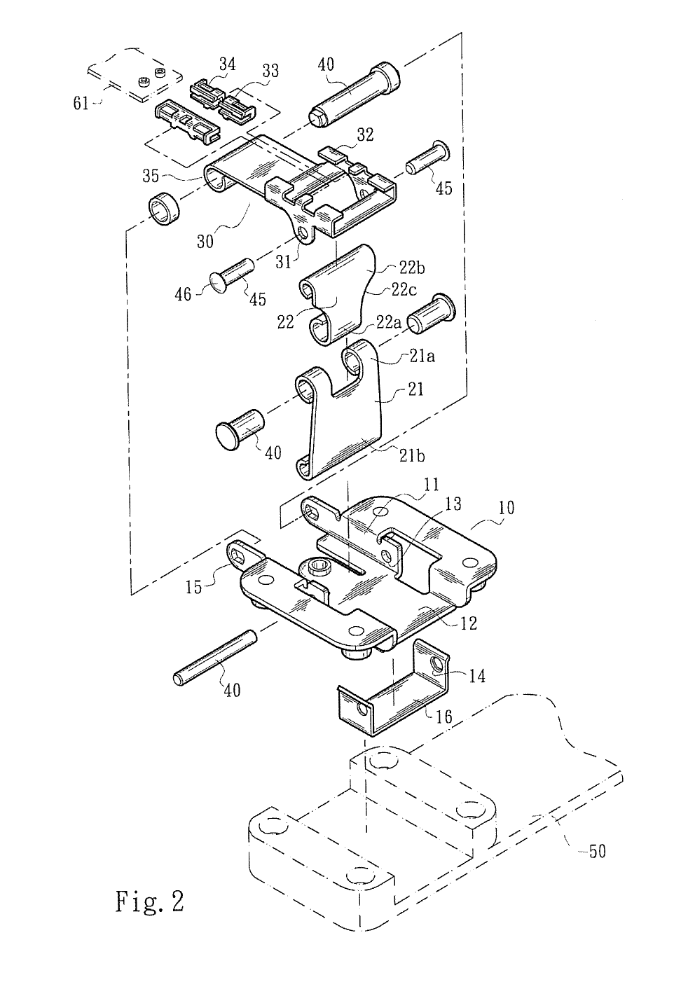

Referring to FIGS. 1, 2 and 3, a rotary shaft device of the present invention comprises a seat 10, a steering arm 20 and a tractor 30. The seat 10, selected of a type of a plate and shaped with a profile having a type of a similar reverse U-shaped section by press forming, comprises two side walls 11 and an end wall 12 to define a type of a similar recess therebetween. In the adopted embodiment, the seat 10 can be attached to a related component of a movable body or a sliding module 50 of an electronic device represented by imaginary line in FIG. 2.

In FIG. 1, the steering arm 20 is formed of rotatable or pendular type by pivoting to the seat 10. In the preferable embodiment represented in FIG. 2, the side walls 11 of the seat 10 are provided with holes 13, and the steering arm 20 is pivoted to the seat 10 by mating a fastener 40 to the holes 13 of the side walls 11 of the seat 10.

In the adopted embodiment, the steering arm 20 comprises a first arm 21 defined with a first end 21a and a second end 21b and a second arm 22 defined with a first end 22a and a second end 22b. In FIG. 2, it is seen that the second arm 22 of the steering arm 20 comprises an arc waist portion 22c.

The first end 21a of the first arm 21 and the first end 22a of the second arm 22 of the steering arm 20 are pivoted to each other by a fastener 40 and formed of a rotatable or pendular type, the second end 21b of the first arm 21 of the steering arm 20 is pivoted to the holes 13 of the seat 10, and the second end 22b of the second arm 22 of the steering arm 20 is pivoted to the tractor 30.

It is needed to specify that, with the pivotal tightness of the first end 21a of the steering arm 20 and the seat 10 or the first and second arms 21 and 22 of the steering arm 20, the first and second arms 21 and 22 of the steering arm 20 in rotation or swinging condition can be positioned as the external force is removed.

In FIG. 2, the tractor 30 is a type of a plate providing holes 31 thereon. The second end of the second arm 22 of the steering arm 20 is pivoted to the holes 31 of the tractor 30 by a fastener or a stud 45. In the adopted embodiment, the tractor 30 is provided with a hand portion 32 and a lining member 33 assembled to the hand portion 32. With the hand portion 32 and the lining member 33, the tractor 30 can be attached to a rail 61 (as shown in FIG. 1) disposed on a fixed body 60 (as shown in FIG. 3), at least movable between a first position and a second position, and the detailed contents will be described hereinafter.

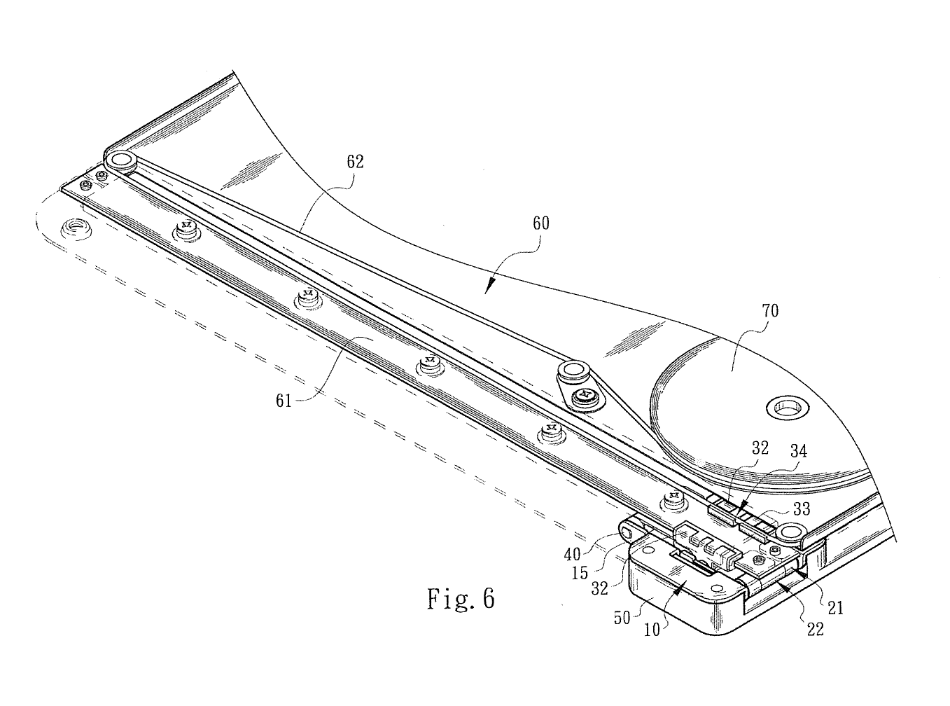

In FIG. 2, the hand portion 32 of the tractor 30 is provided with a limit portion 34 utilized to attach or assemble with a wire 62 (see FIG. 6), so that the tractor 30 can be moved by the wire 62 and the sliding module 50. The limit portion 34 disposed on the lining member 33 is formed of a type of a rabbet. The tractor 30 is also provided with a pivotal end 35 pivoted to the seat 10 by mating with a fastener 40. Specifically, the seat 10 is provided with a pivotal portion 15 corresponding to the pivotal end 35 of the tractor 30, and the pivotal end 35 of the tractor 30 is assembled to the pivotal portion 15 of the seat 10 by mating with the fastener 40.

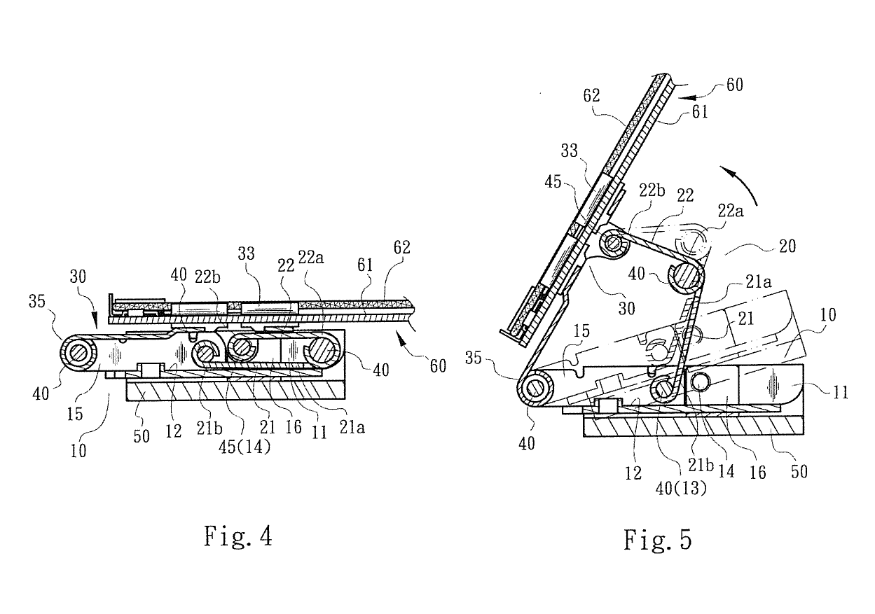

Referring to FIGS. 3 and 4, the seat 10 is attached to the related component of the movable body or the sliding module 50 of the electronic device, and the tractor 30 is attached to the rail 61 of the fixed body 60. In FIGS. 3 and 4, the tractor 30 located on the rail 61 is defined as the first position (or an open position of the sliding module 50).

It is therefore that a position of the first and second arms 21 and 22 of the steering arm 20 controlled by an user is particularly described in FIGS. 3 and 4. The first and second arms 21 and 22 of the steering arm 20 is formed of a type of a similar toggle mechanism utilized to support the sliding module 50 or the related components (e.g., sliding covers, monitors, etc.) in a service position or condition. That is, with the pivoting and locating functions of the seat 10, the first and second arms 21 and 22 of the steering arm 20, and the tractor 30, the user is allowed to adjust an opening angle of the related components of the sliding module 50 to change the viewing angle of the sliding module 50 (or sliding covers, monitors), as shown by imaginary line of FIG. 5.

FIG. 5 shows the condition of the steering arm 20 to be pressed in the seat 10. Specifically speaking, the first arm 21 of the steering arm 20 takes a place where the second end 21b of the first arm 21 is pivoted to the holes 13 of the seat 10 as a fulcrum, the second arm 22 of the steering arm 20 takes a place where the first end 22a of the second arm 22 is pivoted to and the first end 21a of the first arm 21 as a fulcrum. Further, the tractor 30 takes two places, where the holes 31 thereof are pivoted to the second end 22b of the second arm 22 and the pivotal end 35 as well as the pivotal end 35 thereof is pivoted to the pivotal portion 15 of the seat 10, as fulcrums, respectively. Accordingly, the folded first and second arms 21 and 22 of the steering arm 20 can be received in the recess of the seat 10.

In the adopted embodiment, when the steering arm 20 and the seat 10 are folded into a condition similar to that in FIG. 5, the user can push the sliding module 50 to move the tractor 30, the steering arm 20 and the seat 10 to the condition of the second position (or a closed position of the sliding module 50) shown in FIG. 6. That is, when the user drives the sliding module 50 to move the seat 10, the seat 10 driven by the first and second arms 21 and 22 of the steering arm 20 drives the tractor 30 to move along the rail 61. When the tractor 30 is moved to the second position, the structure of the first and second arms 21 and 22 of the steering arm 20 is allowed to be swung or rotated so as to change the viewing angle of the sliding module 50 and the related components thereof.

It is required to explain in that in FIG. 6 a condition of assembly of the rotary shaft device and a wire 62 for accessory movement of the sliding module 50 is specifically represented. When the tractor 30 is moved between the first position and the second position, the limit portion 34 of the hand portion 32 of the tractor 30 drives the wire 62 to move a transmission mechanism or a belt wheel 70. The wire 62 and the transmission mechanism or the belt wheel 70 are utilized to assist the sliding module 50 in increasing the motion stability and smoothness, and effort-saving effect. It is understood that the user is allowed to operate the steering arm 20 to the positions as described in FIGS. 3 and 4 when the tractor 30 is moved from the second position to the first position in FIG. 6.

Referring again to FIG. 2, in a preferred embodiment, the side walls 11 of the seat 10 are provided with pockets or positioning holes 14, and the fastener or stud 45 utilized to pivot the second end 22b of the second arm 22 of the steering arm 20 and the holes 31 of the tractor 30 has protrusions 46 corresponding to the positioning holes 14 of the seat 10, respectively. When the folded first and second arms 21 and 22 of the steering arm 20 is received in the recess of the seat 10, the protrusions 46 of the fastener or stud 45 are embedded or engaged in the positioning holes 14 of the seat 10 to assist in fastening the steering arm 20, thus increasing the stability of the folded structure of the steering arm 20 and the seat 10. It is understood that the assembling structure of the positioning holes 14 and the protrusions 46 can be altered or inversed. For example, the protrusions are formed on the seat 10, and the pockets or positioning holes are formed on the fastener or stud 45.

In a modified embodiment, the positioning holes 14 are formed on an attachment 16. The attachment 16, preferably made of an elastic material, is formed of a type of an elastic plate. With the elasticity of the attachment 16, when the protrusions 46 of the fastener or stud 45 are embedded or engaged in the positioning holes 14 of the seat 10, a closure or fixation condition can be achieved therebetween.

It is obvious that the attachment 16 and the seat 10 can be formed of a type of integral formation. In the described embodiment, the seat 10 and the attachment 16 are a type of two individual independent components detachably assembled to each other. The elastic attachment 16 can be directly assembled to the seat 10 to form a type of an integral structure. With the seat 10 and the attachment 16 formed of two individual independent components, it only has to replace the worn attachment 16 with new one after a long-term operation, i.e., rather than to entirely change the seat 10 or the rotary shaft apparatus rotary shaft device.

Typically speaking, with the co-operative movement of the auxiliary sliding module, the rotary shaft device of the invention for the sliding module provides the following particular considerations and advantages, compared to conventional skills.

With the pivotal assembly structure of the seat 10, the first and second arms 21 and 22 of the steering arm 20 and the tractor 30, the rotary shaft device can be utilized to change the viewing angle of the related components of the sliding module 50. With the arrangement and assembly of the tractor 30 and the rail 61 or the wire 62, the rotary shaft device can have move mechanism with relation to the sliding module 50 moved between the open position and the closed position. The rotary shaft device provides a simplified structure and reduced production and assembly costs, compared to the conventional skills.

Further, the rotary shaft device of the invention can assist in increasing the operation stability of the sliding module 50. That is, by cooperating the guidance of the seat 10, the tractor 30 and the rail 61 with the sliding module 50, the unsmooth operation of conventional skills, or shakiness or swing caused by the user applying a single side-pushing force to operate the sliding cover module 50 or mechanism can be minimized, thus increasing the operation smoothness and stability of the sliding cover module 50 and the wire 62.

To sum up, the invention provides an effective rotary shaft device suitable for the sliding cover module and a particular space configuration much different from that in the conventional skills, and therefore the advantages and improvements of the invention certainly surpass the conventional skills.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A rotary shaft device for a sliding module, comprising:
a seat;
a steering arm, formed of a rotatable type by pivoting to the seat; and
a tractor, pivoted to the steering arm and being attachable to a rail, the tractor moved on the rail at least between a first position and a second position.

2. The rotary shaft device for the sliding module as claimed in claim 1, wherein the seat, selected of a type of a plate and formed with a profile having a type of a similar reverse U-shaped section, comprises a side wall and an end wall to define a type of a similar recess.

3. The rotary shaft device for the sliding module as claimed in claim 1, wherein the seat is attached to the sliding module of an electronic device.

4. The rotary shaft device for the sliding module as claimed in claim 1, wherein the seat comprises a side wall provided with hole and at least one end wall, and the steering arm is pivoted to the seat by mating a fastener to the hole of the side wall of the seat.

5. The rotary shaft device for the sliding module as claimed in claim 1, wherein the steering arm comprises a first arm defined with a first end and a second end and a second arm defined with a first end and a second end.

6. The rotary shaft device for the sliding module as claimed in claim 5, wherein the first end of the first arm and the first end of the second arm of the steering arm are pivoted to each other by a fastener and formed of a rotatable type, the second end of the first arm of the steering arm is pivoted to the seat, and the second end of the second arm of the steering arm is pivoted to the tractor.

7. The rotary shaft device for the sliding module as claimed in claim 5, wherein the second arm of the steering arm comprises an arc waist portion.

8. The rotary shaft device for the sliding module as claimed in claim 5, wherein the tractor is provided with a hole pivoted to the second end of the second arm of the steering arm by a fastener or a stud.

9. The rotary shaft device for the sliding module as claimed in claim 1, wherein the tractor is provided with a hand portion and a lining member assembled to the hand portion.

10. The rotary shaft device for the sliding module as claimed in claim 1, wherein the tractor is provided with a hand portion, and the hand portion is provided with a limit portion utilized to attach a wire.

11. The rotary shaft device for the sliding module as claimed in claim 10, wherein the limit portion is formed of a type of a rabbet.

12. The rotary shaft device for the sliding module as claimed in claim 9, wherein the lining member is provided with a limit portion.

13. The rotary shaft device for the sliding module as claimed in claim 12, wherein the limit portion is formed of a type of a rabbet.

14. The rotary shaft device for the sliding module as claimed in claim 1, wherein the tractor is provided with a pivotal end pivoted to the seat by mating with a fastener.

15. The rotary shaft device for the sliding module as claimed in claim 14, wherein the seat is provided with a pivotal portion corresponding to the pivotal end of the tractor, and the pivotal end of the tractor is assembled to the pivotal portion of the seat by mating with a fastener.

16. The rotary shaft device for the sliding module as claimed in claim 1, wherein the tractor is a type of a plate.

17. The rotary shaft device for the sliding module as claimed in claim 1, wherein the rail is disposed on a fixed body.

18. The rotary shaft device for the sliding module as claimed in claim 4, wherein the side wall of the seat is provided with a positioning hole, and a fastener or stud utilized to pivot the tractor and the second end of the second arm of the steering arm has a protrusion corresponding to the positioning hole of the seat.

19. The rotary shaft device for the sliding module as claimed in claim 4, wherein the side wall of the seat is provided with a protrusion, and a fastener or stud utilized to pivot the tractor and the second end of the second arm of the steering arm has a positioning hole corresponding to the protrusion of the seat.

20. The rotary shaft device for the sliding module as claimed in claim 1, wherein the seat comprises an attachment formed with a positioning hole.

21. The rotary shaft device for the sliding module as claimed in claim 1, wherein the seat comprises an attachment formed with a protrusion.

22. The rotary shaft device for the sliding module as claimed in claim 20, wherein the attachment made of an elastic material is formed of a type of an elastic plate.

23. The rotary shaft device for the sliding module as claimed in claim 21, wherein the attachment made of an elastic material is formed of a type of an elastic plate.

24. The rotary shaft device for the sliding module as claimed in claim 20, wherein the seat and the attachment are a type of two individual independent components detachably assembled to each other.

25. The rotary shaft device for the sliding module as claimed in claim 21, wherein the seat and the attachment are a type of two individual independent components detachably assembled to each other.

26. The rotary shaft device for the sliding module as claimed in claim 20, wherein the seat and the attachment are formed of a type of integral formation.

27. The rotary shaft device for the sliding module as claimed in claim 21, wherein the seat and the attachment are formed of a type of integral formation.
